(19) United States
(12) Patent Application Publication
(10) Pub. No.: US 2011/0231049 A1
(43) Pub. Date: Sep. 22, 2011

(54) METHOD FOR CONTROLLING OPERATION OF A HYBRID AUTOMOTIVE AND VEHICLE ADAPTED TO SUCH A METHOD

(75) Inventors: Philippe Le Brusq, Lyon (FR); Michel Lou Mottier, Saint Bonnet de Mure (FR); Michael Millet, Moldieu-Detourbe (FR)

(73) Assignee: Renault Trucks, Saint Priest (FR)

(21) Appl. No.: 13/131,885

(22) PCT Filed: Dec. 8, 2008
(86) PCT No.: PCT/IB2008/055671

§ 371 Date: May 31, 2011

(51) Int. Cl. B60W 20/00; B60W 10/06; B60W 10/08

(52) U.S. Cl. 701/22; 477/3; 180/65.265; 903/902

(57) ABSTRACT

A method is provided for controlling operation of a hybrid automotive vehicle equipped with at least an internal combustion engine and an electric machine, each adapted to deliver torque to a driveline of the vehicle. This method includes at least the following steps: a) determination of the ability of the engine to deliver torque to an output shaft and allotment of a value to a first parameter on the basis of this determination, b) determination of the ability of the electric machine to deliver torque to its output shaft and allotment of a value to a second parameter on the basis of this determination, d) computation of a value of a global parameter, on the basis of the respective values of the first and second parameters, and e) generation of an electric or electronic signal representative of the value of the global parameter. The hybrid automotive vehicle of the invention includes means to generate an electronic signal depending on the ability of the engine and/or the electric machine to move the vehicle.

### BACKGROUND AND SUMMARY

This invention concerns a method for controlling operation of a hybrid automotive vehicle equipped with at least an internal combustion engine and an electric machine, each adapted to deliver torque to a driveline of the vehicle. The invention also concerns a hybrid automotive vehicle adapted to perform such a method.

In non-hybrid automotive vehicles, the driver is aware that the vehicle can move because he or she hears the internal combustion engine running. Moreover, some information may be displayed on the dashboard of the vehicle on the basis of the rotation speed of the engine. For instance, warning lights which are active when the user is about to start the engine, automatically switch off when the engine is running. This is interpreted by the driver as showing that the engine is running and the vehicle is ready to move.

On hybrid vehicles, such an approach cannot be valid since the vehicle may be ready to go whereas the internal combustion engine is shut down, if an electric motor is provided with electrical energy in a quantity sufficient to move the vehicle.

In other words, the technique used so far for conventional vehicles is not adapted for hybrid vehicles.

This implies that a driver may not notice that the vehicle is ready to move and he may then press down the accelerator pedal which will initiate an unexpected forward or backward movement of the vehicle, potentially dangerous if the driver has actually no intention to move the vehicle.

Moreover, industrial vehicles, such as trucks, are often equipped with accessories belonging to sub-units provided by bodybuilders. These accessories can be, for example, an end-dump body or an electric tailgate. In addition, automotive vehicles are equipped with sub-systems which need energy when the vehicle is moving, such as a heating system in the driver's compartment, a heating seat, a heating mirror, lights, electric tailgate or a winch. In conventional vehicles, these sub-systems can be powered on the basis of the rotation speed of the engine. This is not appropriate with a hybrid vehicle, insofar as energy can be also available from another source, namely the electric machine working as a motor or the battery set associated to the electric machine.

An aspect of this invention aims at proposing a new method for controlling operation of a hybrid automotive vehicle which enables a driver and/or subsystems and accessories to actually take into account the real status of the vehicle in order to determine what actions are to be taken. To this end, an aspect of the invention concerns a method for controlling operation of a hybrid automotive vehicle equipped with at least an internal combustion engine and an electric machine, each adapted to deliver torque to a driveline of the vehicle. This method is characterized in that it comprises at least the following steps: a) determination of the ability of the engine to deliver torque to an output shaft and allotment of a value to a first parameter, on the basis of this determination b) determination of the ability of the electric machine to deliver torque to its output shaft and allotment of a value to a second parameter, on the basis of this determination d) computation of a value of a global parameter, on the basis of the respective values of the first and second parameters and e) generation of an electric or electronic signal representative of the value of the global parameter. Thanks to an aspect of the invention, the electronic signal representative of the value of the global parameter can be used in the vehicle to inform either the driver or some sub-systems and accessories of the ability of the driveline to move the vehicle, irrespective of whether or not the internal combustion engine is actually running.

According to further aspects of the invention which are advantageous but not compulsory, such a method might incorporate one or several of the following features:

Prior to step d), the method comprises a step c) of determination of the ability of the gearbox to transmit torque from its input shaft to its output shaft and allotment of a value to a third parameter, on the basis of this determination, whereas in step d), computation of the value of the global parameter is made also on the basis of the third parameter.

A further step f) is used where the electronic signal is emitted on an onboard network of the vehicle. In such a case, at least one sub-system of the vehicle can check the value of the global parameter by accessing the electric signal on the network, prior to using power for fulfilling its function.

Display of an information representative of the global parameter, on the basis of the electronic signal, takes place in another step g), after step e). Energizing of some auxiliary equipments is possible only if the value of the global parameter equals a predetermined value.

The global parameter can take a first value and a second value corresponding respectively to a first configuration of the driveline, where it cannot move the vehicle, and a second configuration of the driveline, where it can move the vehicle. In such a case, the global parameter can, optionally, take a third value corresponding to a third configuration of the powertrain where it is switching from its first configuration to its second configuration.

The global parameter takes its second value when either the engine or the electric machine is able to deliver torque to its respective output shaft, or when both the engine and the electric machine are able to deliver torque to their respective outputs shafts, whereas the gearbox is enabled to respond to a commutation order.

The invention also concerns, according to an aspect thereof, a hybrid automotive vehicle with which the above-mentioned method can be implemented. More precisely, the invention concerns a hybrid automotive vehicle equipped with at least an internal combustion engine and an electric machine, each adapted to deliver torque to a driveline of the vehicle. This vehicle is characterized in that it includes means to generate an electric or electronic signal depending on the ability of the engine and/or the electric machine to move the vehicle. Thanks to the invention, the electronic signal is representative of the possibility to move the vehicle, independently of the actual source of torque delivered to the driveline, be it the internal combustion engine or the electric machine, working as a motor.

According to an advantageous aspect of the invention, the above-mentioned means are adapted to generate the electric or electronic signal on the basis of at least two unitary signals respectively representative of the ability of the engine to deliver torque to an output shaft and the ability of the electric machine to deliver torque to its output shaft. The above-mentioned means can also be adapted to generate the signal on the basis of a third unitary signal representative of the ability of the gearbox to transmit torque from its input shaft to its output shaft.

Advantageously, the vehicle includes, within its driver's compartment, display means adapted to display an information representative of the above-mentioned electric or electronic signal.

### BRIEF DESCRIPTION OF THE DRAWINGS

The invention will now be explained in correspondence with the annexed figures and as an illustrative example, without restricting the object of the invention. In the annexed figures:

FIG. 1 is a schematic representation of a truck embodying the invention,

FIG. 2 is a partial representation of a communication system belonging to the truck of FIG. 1, and

FIG. 3 is a block diagram representing a method of the invention.

### DETAILED DESCRIPTION

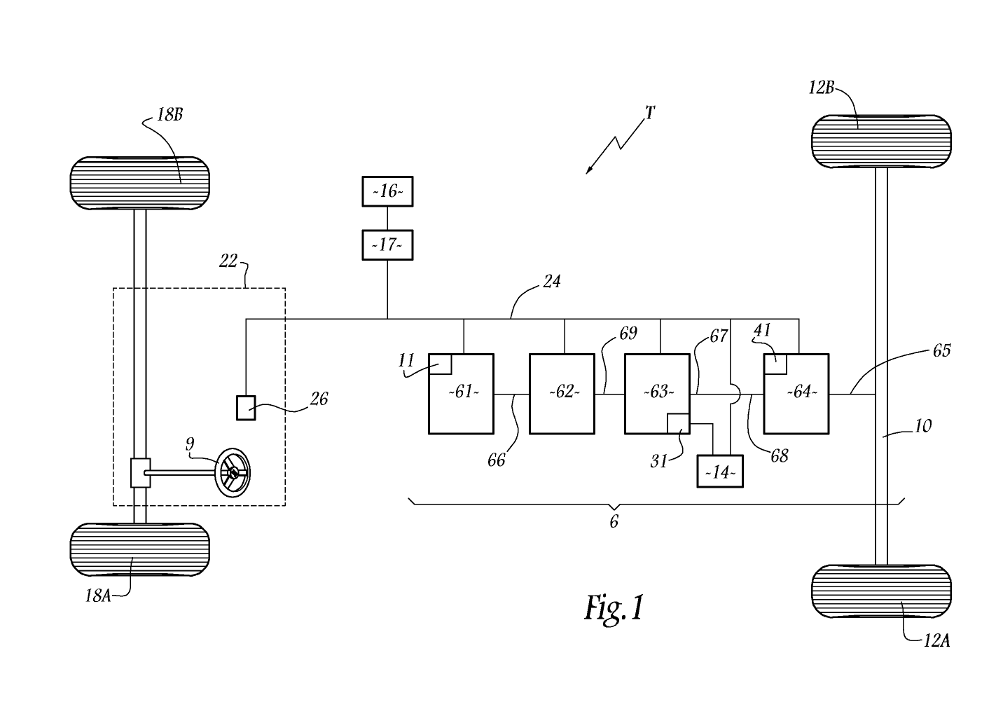

Truck T represented on FIG. 1 is provided with an internal combustion engine 61, a clutch 62, a reversible electric machine 63 and a gearbox 64. The output shaft 65 of gearbox 64 drives the rear axle 10 of truck T which drives two rear wheels 12A and 12B. Gearbox 64 can be for example an automated stepped gearbox or a continuously variable transmission (CVT).

66 denotes the crankshaft of the engine 61, that is its output shaft. Shaft 66 forms or drives the input shaft of clutch 62. 67 denotes the output shaft of electric machine 63 when it works as a motor and 68 denotes the input shaft of gearbox 64. Output shaft 67 and input shaft 68 are either fast in rotation with each other or made of one piece.

A transmission shaft 69 connects clutch 62 to electric machine 63.

The powertrain of truck T includes items 61 to 69 and the driveline 6 of truck T includes this powertrain and axle 10.

Electric machine 63 is connected to a battery set 14 and to an electronic control unit or ECU 16 which pilots systems and equipments of truck T, including items 61 to 64. Electric machine can work either as an electric generator to load battery set 14 or as an electric motor to deliver torque to the crankshaft 67 of engine 61.

Truck T is also provided with front wheels 18A and 18B controlled by a steering wheel located in the driver's compartment 22. A controller area network (CAN) 24 is provided on truck T and allows communications between different systems and equipments onboard truck T.

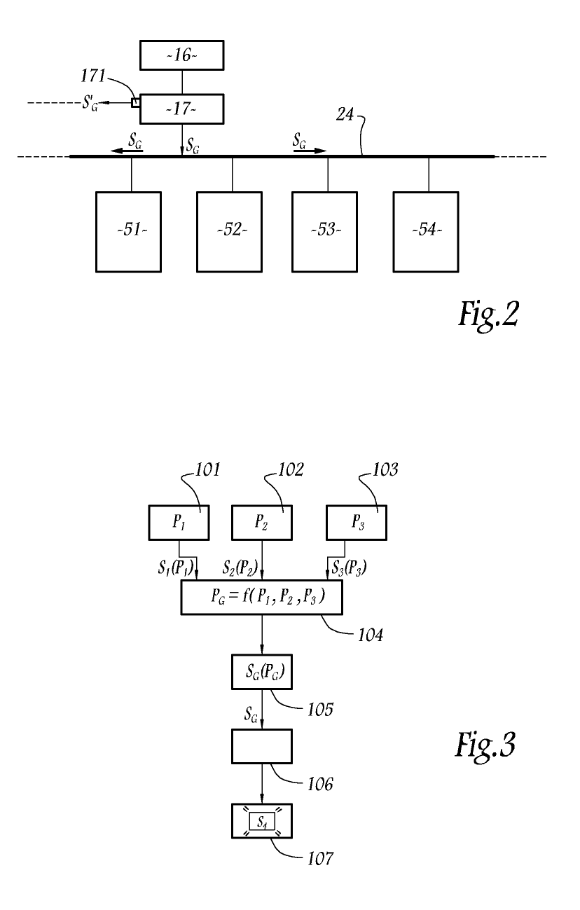

As shown on FIG. 2, an accessories subsystem 51 is connected to CAN 24. Subsystem 51 includes a power steering assembly with a pump, and the lighting system of the truck. A brake subsystem 52 is also connected to CAN 24, together with a cab subsystem 53 which includes, amongst others, heating means for the driver's compartment 22, for the driver's seat and for the external minors of truck T. A fourth subsystem 54 is connected to CAN 24 and is supposed to be connected to elements provided by a bodybuilder, such as driving means for a dump body, a winch or an electrical tailgate. A first detection cell 11 is mounted on engine 61 and allows to detect if engine 61 is running or not For instance, detection cell 11 can be a cell detecting the rotation speed of engine 61.

A first step 101 of the method of the invention can be implemented with detection cell 11. In this step, one determines if engine 61 is running or not, on the basis of its rotation speed. A first parameter P1 is determined in the following manner: if the engine is stopped, parameter P1 takes value 0 and if the engine is running, parameter P1 takes value 1.

Alternatively, parameter P1 can be determined by ECU 16 on the basis of several unitary signals representative of whether or not engine 61 is started and whether or not the clutch 62 is active to transmit a torque, whether or not its cooling sub-system works properly and whether or not its electronic drive unit works properly.

Irrespective of its actual computation method, parameter P1 is representative of the ability of engine 61 to deliver a torque to its output shaft 66.

In a second step 102 of the method, one determines whether electric machine 63 can work as a motor to deliver torque to its output shaft 67. More precisely, a detection cell 31 is provided in electric machine 63 and detects the actual load of battery set 14 and the status of electric machine 63. On the basis of this detection, a parameter P2 takes two values, namely 0 if this machine cannot provide torque to the shaft 67 and 1 if this machine can actually provide torque to the shaft 67. P2 may depend on further conditions, such as whether the electric machine cooling system works properly, whether or not the hazardous voltage interlock system (HVIL) works properly, whether or not the battery works properly, etc . . . If truck T is provided with a tension converter (600V/24V), then a further condition can be verified to allot value 1 to parameter P2, that is the fact that this converter works properly. This verification is part of the determination of parameter P2.

In a third step 103 of the method, one determines, with a cell 41, if gearbox 64 is enabled, that is if it can actually respond to a commutation order, i.e. an order to change the speed ratio or to switch from a neutral state where no torque is transmitted through the gearbox to a state where torque can be transmitted from the input shaft 68 to the output shaft 65 of the gearbox. If gearbox 64 is enabled, a third parameter P3 takes value 1. If this is not the case, parameter P3 takes value 0.

The order of steps 101, 102 and 103 is only indicative and these three steps can occur in any order, or at least partly simultaneously. The respective values of parameters P1, P2 and P3 are transmitted to ECU 16, via CAN 24 and a telecommunication electronic control unit 17, in the form of three electronic unitary signals S1, S2 and S3.

A global parameter PG is computed in ECU 16, as a function of parameters P1, P2 and. P3. This global parameter is representative of the ability for powertrain 6 to move truck T. Such is the case when gearbox 64 is enabled and when either engine 61 or electric machine 63 is active or when both of these machines are active. The value of global parameter PG can therefore be equal to 0 when both engine 61 and electric motor 63 are stopped or not in a configuration to provide torque to their respective output shafts 66 and 67 or when gearbox 64 is not enabled. On the contrary, parameter PG takes value 1 if engine 61 is running and gearbox 64 is enabled and/or if engine 63 is active and gearbox 64 is enabled.

In other words, the value of parameter PG is a function f of the respective values of parameters P1, P2 and P3, which can be written

In a further step 105 of the method, the value of parameter PG is incorporated into an electronic signal SG which is generated by telecommunication ECU 17 and sent to CAN 24 in a further step 106. Signal SG is then available for subsystems 51 to 54 which can all determine if driveline 6 is in a configuration to move truck T or in a configuration where it cannot move truck T.

Signal SG can also be sent by a display 26 located in the driver's compartment 22 and providing the driver with an information with respect to the actual status of power train 6, on the basis of the actual value of PG. If PG equals 0, display 26 shows that powertrain 6 is not active. If PG equals 1, display 26 shows that powertrain 6 is active. This takes place in a further step 107 of the method. in other words, the driver can check on display 26 if driveline 6 is active to move truck T or not, without having to rely on the noise usually made by the internal combustion engine 61. This is appropriate insofar as power can also come from the electric motor 63 which is silent when active.

Alternatively or in addition, actuation of display 26 can be made directly by transmission ECU 17 which sends a dedicated signal S′G to display 26 via a dedicated output 171 and a non-represented network.

The method of the invention can be implemented as long as ECU 16 is under tension, so that signal SG is available for all subsystems 51 to 54 when any one of these systems is likely to request an information with respect to the status of powertrain 6. Therefore, subsystems 51 to 54 do not have to initiate a special proceeding to check the status of engine 61 and electric machine 63 prior to fulfilling their functions. Each subsystem 51 to 54 can check the value of PG on network 24 by accessing and reading signal SG. The respective control units of subsystems 51 to 53 are set to allow these subsystems to fulfill their functions only if signal SG conveys value 1 of global parameter PG, that in case powertrain 6 is active to move truck T.

Moreover, display of the information corresponding to parameter PG in the driver's compartment 20 avoids the driver to unduly try to re-start the engine 61, whereas power train 6 is already active.

According to an advantageous aspect of the invention, which is not compulsory, Parameters P1, P2 and P3 can take three values, namely the two values 0 and 1 mentioned here-above and a value corresponding to an intermediate situation, respectively when one of items 61, 63 and 64 is in the process of changing from an inactive state to an active state. This enables parameters PG to also take three values and signal SG to vary accordingly, so that an information can be shown on display 26 when one or several of the components of powertrain 6 are in the process of reaching an active state. Parameter PG takes its third value, which can be 0.5, when one of elements 61, 63 or 64 is switching from a non-active configuration to an active configuration, that is when driveline 6 is actually switching from a configuration where it cannot move truck T to a configuration where it can move truck T.

According to another approach, global parameter PG can take different values different from 0, depending on the active parts of powertrain 6. For instance, parameter PG can take value 1 if only engine 61 is active to deliver torque to crankshaft 67, value 2 if only electric motor 63 is active to deliver torque to crankshaft 67 and value 3 if both engine 61 and electric motor 63 are active.

These values 1, 2 or 3 of parameter PG assume that gearbox 64 is enabled. These different values of parameter PG can be incorporated into signal SG and used by subsystems 51 to 54 to determine if they can fulfill their respective functions and display 26 to inform the driver, as mentioned here-above.

The invention is applicable irrespectively of the actual architecture of the driveline 6 of the truck T. In particular, the arrangement and order of items 61, 62, 63 and 64 can be modified. It can be applied to different hybrid electric vehicle architectures, especially to parallel and series/parallel “power split” architectures.

With the invention, it is not compulsory to take into account the status of gearbox 64. In other words, computation of global parameter PG can be based on first and second parameters P1 and P2 only and step 103 is optional. PG is then a function f of parameters P1 and P2 which can be written:

PG=f(P1,P2)

The parameter PG can be used as follows. Depending on the values of parameter PG the vehicle can be operated in different modes. For example, when PG=1, the followings mode are available: i) hybrid mode, that is when clutch 62 is active to transmit a torque, engine 61 is running, its cooling system works properly, machine 63 is active, its cooling system works properly, the Hazardous Voltage Interlock (HVIL) works properly, the electric machine works properly and the battery works properly (P1=1, P2=1) ii) electric only mode, that is when no fuel is injected in engine 61 and when machine 63 is active, its cooling system works properly, the HVIL works properly, the electric machine works properly and the battery works properly (P1=0, P2=1) iii) internal combustion only mode, that is when clutch 62 is active to transmit a torque, engine 61 is running, its cooling system works properly and machine 63 is not active (P1=1, P2=0) iv) electric mode only with engine 61 idle, that is when clutch 62 does not transmit torque, engine 61 is running, its cooling system works properly, machine 63 is active, its cooling system works properly, the HVIL works properly, the electric machine works properly and the battery works properly (P1=0, P2=1) v) charge at standstill mode, that is when clutch 62 is active to transmit a torque to an alternator, engine 61 is running, its cooling system works properly, machine 63 is active, its cooling system works properly, the HVIL works properly, the electric machine works properly and the battery works properly and the power is temporarily used to load battery set 14.

Alternatively, when PG=0, the following modes can be implemented:

starting mode: engine 61 is being started and the propulsion mode is being initiated (P1=0, P2=0);

switch-off mode when the truck is being switched off (P1=0, P2=0). In this example, parameters P1 may take into account the status of clutch 62, that is whether or not it is active to deliver torque to its output shaft 69. Therefore, parameter P1 is representative of the ability of engine 61 to deliver torque to shaft 69.

The invention has been explained in reference to an embodiment where electronic signals S1, S2 S3 and SG are used. The invention can also be implemented with electric signals, that is non-coded signals which have a voltage value directly depending on their logical value.

The invention is applicable with trucks, buses, cars and any other automotive hybrid vehicle.

1. A method for controlling operation of a hybrid automotive vehicle equipped with at least an internal combustion engine and an electric machine, each adapted to deliver torque to a driveline of the vehicle, comprising:
a) determining a first ability of the engine to deliver torque to an output shaft and allotment of a value to a first parameter based on the first determination,
b) determining a second ability of the electric machine to deliver torque to its output shaft and allotment of a value to a second parameter based on the second determination,
d) computing a value of a global parameter, on the basis of the respective values of the first and second parameters, and
e) generating an electric or an electronic signal representative of the value of the global parameter.

2. Method according to claim 1, comprising prior to step d), a step c) of determining a third ability of the gearbox to transmit torque from its input shaft (68) to its output shaft and allotment of a value to a third parameter (P3) based on the third determination, and wherein, in step d), the computation of the value of the global parameter is made also on the basis of the third parameter.

3. Method according to one of claims 1, comprising a further step of:
f) emitting the electric signal on a onboard network of the vehicle.

4. Method according to claim 3, wherein at least one subsystem of the vehicle checks the value of the global parameter by accessing the electric signal on the network, prior to using power for fulfilling its function.

5. Method according to claim 1, comprising, after step e), a further step of a) displaying information representative of the global parameter, on the basis of the electronic signal.

6. Method according to claim 1, wherein energizing of some auxiliary equipments is possible only if the value of the global parameter equals a predetermined value.

7. Method according to claim 1, wherein the global parameter can take a first value and second value corresponding respectively to:
a first configuration of the driveline where it cannot move the vehicle, and
a second configuration of the driveline where it can move the vehicle, on the basis of an order received.

8. Method according to claim 7, wherein the global parameter can take a third value corresponding to a third configuration of the powertrain where it is switching from its first configuration to its second configuration.

9. Method according to claim 7, wherein the global parameter takes its second value when either the engine or the electric machine is able to deliver torque to a respective output shaft, or when both the engine and the electric machine are able to deliver torque to some output shafts.

10. A hybrid automotive vehicle equipped with at least an internal combustion engine and an electric machine, each adapted to deliver torque to a driveline of the vehicle, wherein the vehicle includes means to generate an electric or electronic signal depending on the ability of the engine and/or the electric machine to move the vehicle.

11. Vehicle according to claim 9, wherein the means are adapted to generate the electric or electronic signal on the basis of at least two unitary signals respectively representative of:
the ability of the engine to deliver torque to an output shaft (66, 69) and
the ability of the electric machine to deliver torque to its output shaft

12. Vehicle according to claim 11, wherein the means are adapted to generate the electric or electronic signal on the basis of a third unitary signal representative of the ability of a gearbox to transmit torque from the its input shaft to its output shaft.

13. Vehicle according to claim 10, wherein it includes, within its driver's compartment, display means adapted to display an information representative of the electric or electronic signal.
